(19) United States
(12) Patent Application Publication
(10) Pub. No.: US 2013/0166269 A1
(43) Pub. Date: Jun. 27, 2013

(54) SIMULATION APPARATUS, SIMULATION METHOD, AND RECORDING MEDIUM

(71) Applicant: FUJITSU LIMITED, Kawasaki (JP)

(72) Inventor: Hiroki NARITA, Kawasaki (JP)

(73) Assignee: FUJITSU LIMITED, Kawasaki (JP)

(21) Appl. No.: 13/674,468

(22) Filed: Nov. 12, 2012

(30) Foreign Application Priority Data
Dec. 22, 2011 (JP) 2011-280643

(51) Int. Cl. G06F 17/50

(52) U.S. Cl. 703/14

(57) ABSTRACT

A simulation apparatus includes a storage device that stores a block of circuit data including a clock gating circuit including a control circuit and a first latch circuit, wherein the control circuit outputs a control signal according to a clock, and wherein the first latch circuit holds or outputs a block of input data according to the control signal; and a processor that executes a program having a procedure. The procedure includes: generating a block of substitution circuit data by substituting the first latch circuit by a selection circuit and a second latch circuit; and performing simulation with respect to the substitution circuit data using a pulse related to the reference clock and the reference clock.

### CROSS-REFERENCE TO RELATED APPLICATIONS

This application is based upon and claims the benefit of priority of the prior Japanese Patent Application No. 2011-280643 filed on Dec. 22, 2011, the entire contents of which are incorporated herein by reference.

### FIELD

The embodiments discussed herein are related to a simulation apparatus, a simulation method and a recording medium which stores a simulation program.

### BACKGROUND

In an operation of logic verification for an internal circuit of a semiconductor device, logic simulation is generally performed. There are two types of logic simulation method: Event Driven simulation and Cycle Based simulation.

Regarding the Event Driven simulation, a signal “1” or a signal “0” is transmitted between logic circuits, and a delay time in the transmission is calculated. Therefore, the Event Driven simulation may perform accurate simulation. On the other hand, regarding the Cycle Based simulation, a cycle in which the state of the logic circuit is a clock is obtained as a unit. The state of the logic circuit, the delay time, and the like of the intermediate of the cycle are not calculated. Therefore, the Cycle Based simulation may perform high-speed simulation.

For example, regarding simulation for logic verification on a Large Scale Integrated circuit (LSI) or the like, as many operations and verification of the state as possible may be desired to be performed in a short time. The logic verification by the Cycle Based simulation, which may perform more operations and state verification per unit of time, may be desired to be performed.

There is a known method as the related art (for example, see Japanese Laid-open Patent Publication No. 08-262104) comprising: an operation for receiving a data signal in an input terminal; an operation for receiving a system clock signal having a system clock frequency; and an operation for receiving a phase clock signal with a frequency that is divided from the system clock frequency, wherein the data signal is transited to an output terminal when the phase clock is active, wherein the data signal is latched when the phase clock signal is active and edge transition of the system clock signal occurs, wherein the latched data signal is again latched when the edge transition of the system clock signal occurs, and wherein the latched data signal is transited to the output terminal when the phase clock signal is inactive.

### SUMMARY

According to an aspect of the invention, a simulation apparatus includes: a storage device that stores a block of circuit data including a clock gating circuit including a control circuit and a first latch circuit, wherein the control circuit outputs a control signal according to a clock, and wherein the first latch circuit holds or outputs a block of input data according to the control signal; and a processor that executes a program having a procedure. The procedure includes: generating a block of substitution circuit data by substituting the first latch circuit by a selection circuit and a second latch circuit, wherein the selection circuit selectively outputs one of the input data and a block of output data according to the control signal, wherein an output of the selection circuit is input into a data input terminal and a reference clock is input into a clock input terminal in the second latch circuit, and wherein the second latch circuit outputs the output of the selection circuit as the output data according to the reference clock from a data output terminal; and performing simulation with respect to the substitution circuit data using a pulse related to the reference clock and the reference clock.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is an explanation diagram of a clock gating circuit;

FIGS. 2A and 2B are explanation diagrams of simulation of the clock gating circuit;

FIG. 3 illustrates an example of a simulation apparatus;

FIG. 4 illustrates an example of a hardware configuration of the simulation apparatus;

FIG. 5 is an explanation diagram of circuit data conversion;

FIGS. 6A and 6B are explanation diagrams of the circuit data conversion;

FIG. 7 is an explanation diagram of the circuit data conversion;

FIG. 8 is an explanation diagram of simulation;

FIGS. 9A and 9B are explanation diagrams of the simulation;

FIG. 10 is another explanation diagram of the simulation;

FIG. 11 illustrates an example of the simulation;

FIG. 12 illustrates another example of the simulation;

FIG. 13 illustrates an example of the simulation; and

FIG. 14 is a simulation processing flow chart.

### DESCRIPTION OF EMBODIMENTS

As for the Cycle Based simulation, delay is not accurately expressed, and there are restrictions such as limitations of a logic circuit that may be subjected to simulation. Therefore, logic verification by the Cycle Based simulation may not be performed.

The embodiments provide a simulation apparatus that may reduce the limitations of the logic circuit, which may be subjected to the simulation.

According to the simulation apparatus disclosed in the embodiments, the logic verification by the Cycle Based simulation may be performed with respect to more logic circuits.

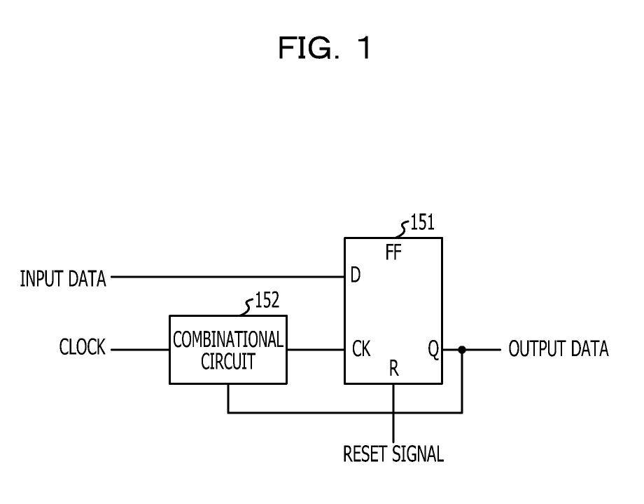

FIG. 1 is an explanation diagram of a clock gating circuit.

The clock gating circuit illustrated in FIG. 1 includes a D-type Flip Flop (hereinafter referred to as FF) 151 and a combinational circuit 152. The clock gating circuit suppresses a consumption power of the FF 151 by stopping a clock supplied to the FF 151 by the combinational circuit 152. As a result, the consumption power of the entire semiconductor device is reduced. The FF 151 is a latch circuit that holds or outputs input data, which is input into a data input terminal D, according to a control signal that is input into a clock input terminal CK. An output of the FF 151 is output from a data output terminal Q. The combinational circuit 152 is a control circuit that outputs the control signal of the FF 151 according to the clock. The supply of the clock to the FF 151 is stopped by the combinational circuit 152.

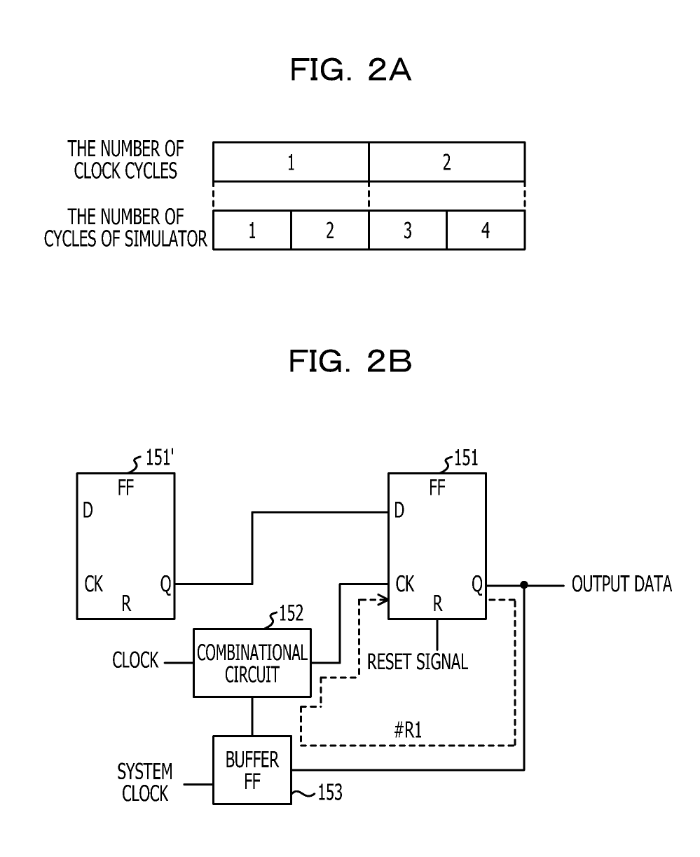

FIGS. 2A and 2B are explanation diagrams of simulation of the clock gating circuit.

As illustrated in FIG. 1, as for the clock gating circuit, the output of the FF 151 is input into the clock input terminal CK of the FF 151 through the combinational circuit 152. Therefore, the Cycle Based simulation apparatus detects a feedback loop that starts from the data output terminal Q to the clock input terminal CK of the FF 151. However, the Cycle Based simulation apparatus may not secure timing for taking in input data. Thus, it is prohibited that the circuit having the feedback loop, in which the output of the logic circuit is given to the clock input of the logic circuit, is subjected to the simulation. Therefore, the Cycle Based simulation may not be performed.

To perform the Cycle Based simulation with respect to the logic circuit having the clock gating circuit, the simulation apparatus, as illustrated in FIG. 2B, inserts a buffer FF 153 into the feedback loop to the clock input terminal CK. The simulation apparatus performs the Cycle Based simulation with respect to the clock gating circuit into which the buffer FF 153 is inserted. The buffer 153 is inserted on simulation circuit data for the simulation. The buffer 153 is not actually inserted into the circuit of the semiconductor device. In this case, an FF 151′ is a logic circuit that is included in the clock gating circuit of a previous stage of the FF 151.

The buffer FF 153 is driven by a system clock of the simulation apparatus. Therefore, the output of the FF 151 is synchronized with a first system clock and is then temporally held by the buffer FF 153. After that, the output is synchronized with the following system clock, and the output of the buffer FF 153 is input into the clock input terminal CK. Due to this, the feedback loop to the clock input terminal CK as indicated with a dashed line in a loop #R1 in FIG. 2B is removed. Accordingly, the Cycle Based simulation may be performed with respect to the logic circuit having the clock gating circuit.

However, it is preferable that after the output of the FF 151 is synchronized with the first system clock and held by the buffer FF 153, the output is synchronized with the following clock, and the output of the buffer FF 153 is input into the combinational circuit 152 and the clock input terminal CK. In other words, it is preferable that in “1 cycle” of the clock used in the clock gating circuit, a first cycle in which the buffer FF 153 receives the output of the FF 151 is separated from a second cycle in which the output is combined with the output of the buffer FF 153 and input into the combinational circuit 152 and the clock input terminal CK.

As illustrated in FIG. 2A, compared to 1 cycle of the clock used in the clock gating circuit, a plurality of cycles for the system clock for simulation are desired. As illustrated in FIG. 2A, the number of clock cycles indicates the number of cycles of the clock that are input into the combinational circuit 152, and “the number of cycles of simulator” indicates the number of cycles of the system clock of the simulation apparatus. As described above, in the 1 cycle of the clock, the first cycle is performed in the first half of the 1 cycle and the second cycle is performed in the last half of the 1 cycle.

As illustrated in FIG. 2A, the number of cycles of the simulator is twice as large as the number of clock cycles. In other words, the ratio between the number of cycles of the simulator and the number of clock cycles is 2:1. Therefore, for the simulation of the 1 cycle of the clock, the system clock for 2 cycles, which is twice as large as 1 cycle, is desired. In other words, the speed of the simulation is reduced by half, for example. Accordingly, compared to the number of cycles of the clock desired for the operation of the clock gating circuit, the number of cycles of the system clock desired for the simulation increases. As a result, calculation efficiency of the simulation apparatus deteriorates.

According to the simulation apparatus disclosed in the present embodiments, the Cycle Based simulation may be performed, without decreasing the efficiency of the simulation in the simulation apparatus, with respect to the logic circuit having the clock gating circuit.

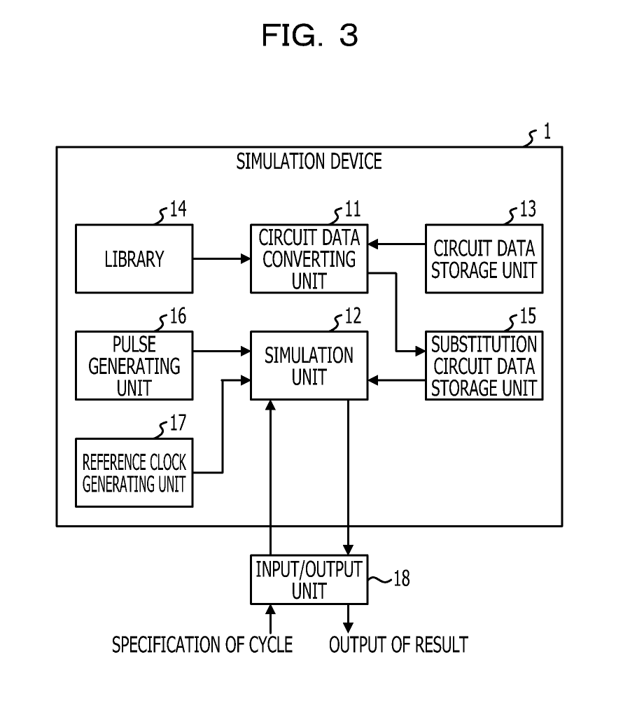

FIG. 3 illustrates an example of the simulation apparatus.

A simulation apparatus 1 includes a circuit data converting unit 11, a simulation unit 12, a circuit data storage unit 13, a library 14, a substitution circuit data storage unit 15, a pulse generating unit 16, a reference clock generating unit 17, and an input/output unit 18.

The circuit data storage unit 13 stores circuit data. For example, the circuit data is generated in advance of the simulation by a computer other than the simulation apparatus 1 and is then stored in the circuit data storage unit 13 through the input/output unit 18. The circuit data indicates a circuit of a semiconductor device that is to be actually manufactured. As illustrated below, the circuit data includes a clock gating circuit that has a control circuit and a latch circuit.

The library 14 stores a pair of a selection circuit and a latch circuit used to substitute the latch circuit included in the clock gating circuit. The library 14 is generated in advance of the simulation.

The circuit data converting unit 11 generates substitution circuit data based on the circuit data read out from the circuit data storage unit 13. The substitution circuit data is generated by substituting the latch circuit for a substitution circuit 5, which has the selection circuit and the latch circuit, in the clock gating circuit in the read-out circuit data. The circuit data converting unit 11 reads out the substitution circuit 5, which has the selection circuit and the latch circuit, from the library 14, and then substitutes the substitution circuit 5 for the latch circuit in the clock gating circuit. The generated substitute data is stored in the substitution circuit data storage unit 15.

The substitution circuit data storage unit 15, which is a storage unit storing substitution circuit data, stores the substitution circuit data generated by the circuit data converting unit 11. The substitution circuit data is equivalent to the circuit data generated based on the circuit data. The substitution circuit data does not indicate the circuit of the semiconductor device that is to be actually manufactured. The substitution circuit data is generated and used for simulation.

The simulation unit 12 performs the Cycle Based simulation with respect to the substitution circuit data. Due to this, since the substitution circuit data is equivalent to the circuit data, the Cycle Based simulation with respect to the circuit data is performed. The simulation unit 12 inputs a pulse as a clock into the control circuit and performs the simulation with respect to the generated substitution circuit data by inputting a reference clock into the latch circuit. The pulse has a previously specified relation with the reference clock.

The pulse generating unit 16 generates a pulse and supplies the simulation unit 12 with the pulse. The simulation unit 12 inputs the supplied pulse as a clock into the control circuit. The pulse may be replaced by the clock. The signal, which is input into a combinational circuit 6 of a clock gating circuit 4 before the substitution illustrated in FIG. 1, is indicated as “pulse” to be separated from the clock that is input into the combinational circuit 6 of a clock gating circuit 3 before the substitution illustrated in FIG. 1.

The clock that is input into the combinational circuit 6 of the clock gating circuit 3 before the substitution is a signal that is actually supplied as an operation clock to the clock gating circuit 3 in the semiconductor device that is to be actually manufactured. The pulse that is input into the combinational circuit 6 of the clock gating circuit 4 after the substitution is a signal that is supplied for simulation to the clock gating circuit 4 existing in the substitution circuit data for simulation.

The reference clock generating unit 17 generates a reference clock and then supplies the simulation unit 12 with the reference clock. The reference clock is a frequency that is equivalent to the pulse or a frequency of an integral multiple. For example, a clock with the highest frequency in the simulation apparatus 1, that is, the system clock of the simulation apparatus 1 is used as the reference clock. Due to this, the Cycle Based simulation may be performed with best efficiency. The system clock is a basic clock used to cause the simulation apparatus 1 to perform a system operation. Clocks other than the system clock may be used as the reference clock.

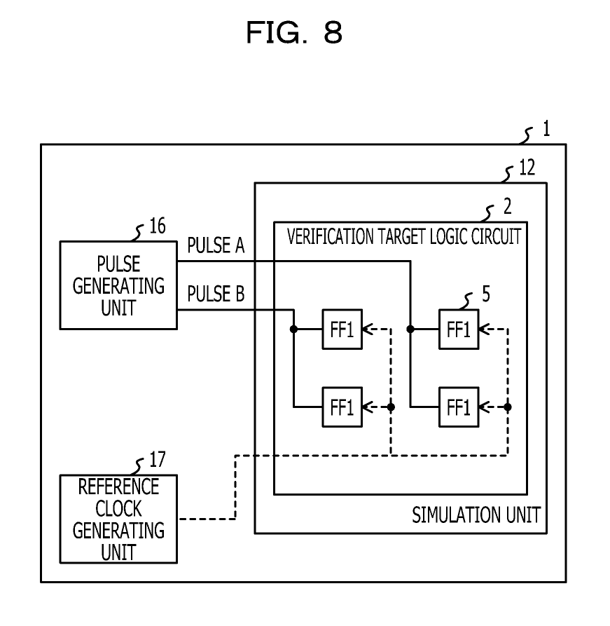

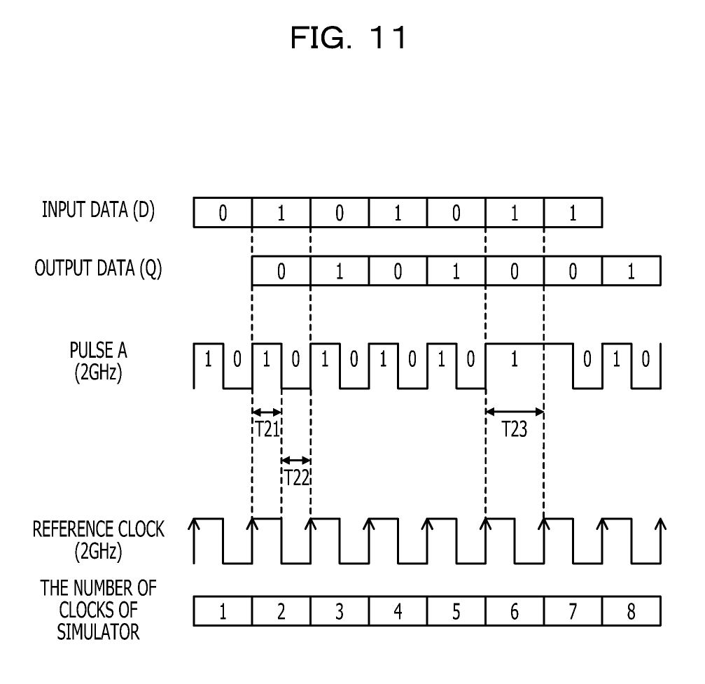

The input/output unit 18 inputs an instruction for specifying the number of cycles of the simulator, which performs the Cycle Based simulation in the simulation unit 12, into the simulation unit 12. Accordingly, the simulation unit 12 performs the simulation of the previously specified number of cycles. In the example illustrated in FIG. 11, the number of cycles indicates the number of cycles of the reference clock. In other words, the number of cycles indicates the number of cycles of the system clock of the simulation apparatus 1. The number of cycles is specified as “100”, for example. Due to this, 100 cycles of the system clock is input into a verification target logic circuit 2 illustrated in FIG. 8, and a state of the verification target logic circuit 2 at this point is obtained as a simulation result.

The input/output unit 18 outputs the simulation result from the simulation 12 on a display screen, for example. The simulation result may be output as a file.

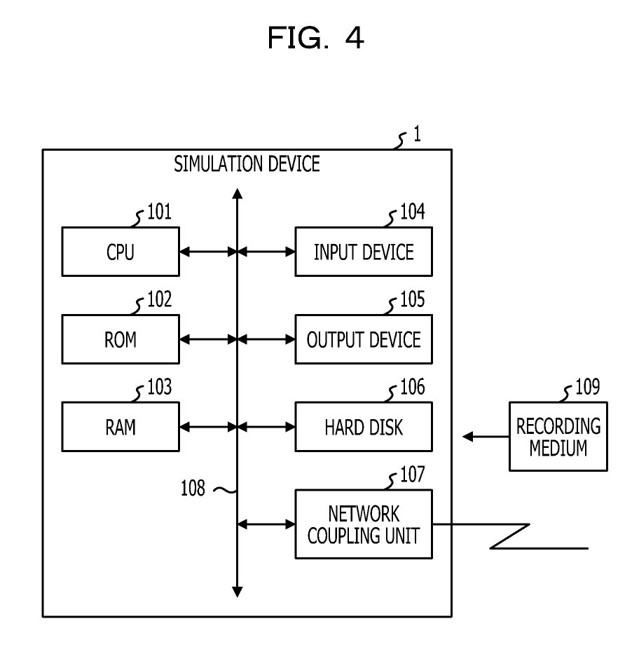

FIG. 4 illustrates a hardware configuration of the simulation apparatus.

A CPU (Central Processing Unit) 101 controls the simulation apparatus 1 according to a control program stored in a ROM (Read Only Memory) 102. The CPU 101 performs, for example, a simulation program on a RAM (Random Access Memory) 103 as a main memory. Due to this, the circuit data converting unit 11 and the simulation unit 12 may be achieved. For example, the simulation program is stored in a recording medium 109 such as CD-ROM (Compact Disc Read Only Memory) and DVD (Digital Versatile Disc), input into a hard disk 106 from the recording medium 109 through a CD-ROM drive, a DVD drive, or the like, and is then loaded into the RAM 103 from the hard disk 106.

The circuit data storage unit 13 and the substitution circuit data storage unit 15 are provided in the hard disk 106, for example. In other words, the data is stored in the hard disk 106, for example. The circuit data is stored in, for example, the recording medium 109 such as CD-ROM and DVD, input into the hard disk 106 from the recording medium 109 through a CD-ROM drive, a DVD drive, or the like, loaded into the RAM 103 from the hard disk 106 if desired, and is then processed by the circuit data converting unit 11 and the simulation unit 12.

An input device 104 is, for example, a keyboard. The input device 104 may include a mouse or the like. An output device 105 is, for example, a display. The output device 105 may include an output device such as printer or the like. The input/output unit 8 includes the input device 104 and the output device 105. The CPU 101, the ROM 102, the RAM 103, the input device 104, the output device 105, the hard disk 106, and a network coupling unit 107 are coupled to each other by a bus 108.

The network coupling unit 107, which is a transmitting/receiving device, for example, is coupled to a network and to another computer through the network. In this manner, the simulation apparatus 1 performs communication with another computer.

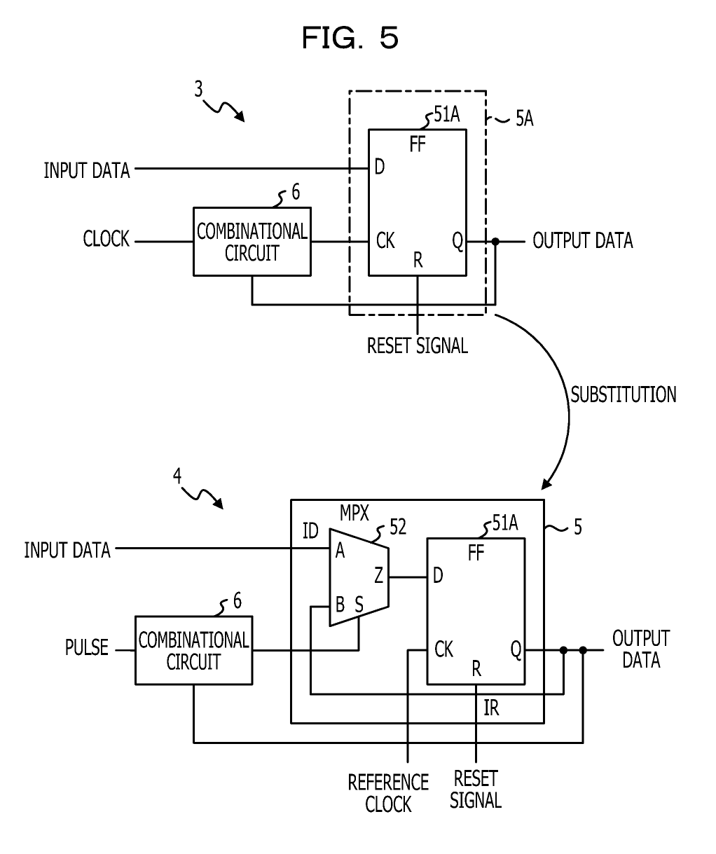

With reference to FIGS. 5, 6 and 7, circuit data converting processing that is performed by the circuit data converting unit 11 will be described in detail below.

FIG. 5 is an explanation diagram of circuit data conversion.

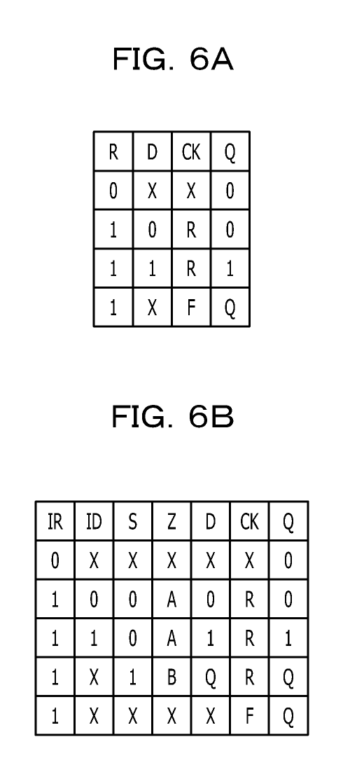

As illustrated in FIG. 6, the clock gating circuit 3 is a circuit included in the circuit data that is read out from the circuit data storage unit 13. In other words, the clock gating circuit 3 is a clock gating circuit before the substitution. The clock gating circuit 3 is included in the semiconductor device that is to be actually designed and manufactured. The clock gating circuit 4 is a circuit included in the substitution circuit data that is generated by the circuit data converting unit 11. In other words, the clock gating circuit 4 is a clock gating circuit after the substitution. The clock gating circuit 4 is a circuit that exists in the simulation substitution circuit data for simulation. As described below, the clock gating circuit 4 is equivalent to the clock gating circuit 3. The clock gating circuit 4 is a circuit that separates a clock system signal from a data system signal in the clock gating circuit 3.

As described above, the circuit data converting unit 11 detects a latch circuit 51A in the circuit data that is read out from the circuit data storage unit 13. As illustrated in FIG. 5, the circuit data converting unit 11 substitutes the detected latch circuit 51A for the substitution circuit 5 that includes a selection circuit 52 and a latch circuit 51. Therefore, the substitution circuit data is generated.

The selection circuit 52 is a multiplexer that inputs the input data into a first data input terminal A, inputs the output data of the latch circuit 51 into a second data input terminal B, and inputs the control signal output from a combinational circuit 6 into a control signal input terminal S. According to the control signal output from the combinational circuit 6, the selection circuit 52 selectively outputs either the input data or the output data of the latch circuit 51 from a data output terminal Z. The combinational circuit 6 is a control circuit that controls the clock gating circuit based on the input clock or pulse.

The latch circuit 51 inputs the output of the selection circuit 52 into a data input terminal D and inputs the reference clock into the clock input terminal CK. According to the reference clock, the latch circuit 51 outputs the output of the selection circuit 52 as output data from the data output terminal Q. The latch circuit 51 includes a reset terminal R into which a reset signal is input.

The output of the combinational circuit 6 is severed from the clock input terminal CK of the FF 51 and is then input into the control signal input terminal S of the selection circuit 52. The input data and an output Q of the FF 51 are input into the input of the selection circuit 52 to hold a value of the FF 51. An output Z of the selection circuit 52 is coupled to a data input terminal D of the FF 51

The signal output from the data output terminal Q of the latch circuit 51 is input into the combinational circuit 6. Furthermore, the signal output from the data output terminal Q of the latch circuit 51 is input also into the input terminal B of the selection circuit 52 and is input into the data input terminal D of the latch circuit 51. The selection circuit 52 is a data system circuit that is coupled to the data input terminal D. Accordingly, the output of the latch circuit 51 is separated and input into the combinational circuit 6 as a clock system circuit and the selection circuit as a data system circuit. As a result, the buffer FF 153 illustrated in FIG. 2B is not typically desired. As described below, an equivalent logic is held in the clock gating circuits 3 and 4 before and after the substitution, and the number of reference clocks, that is, the number of cycles of the system clock of the simulation apparatus 1 is decreased.

Conditions for detection of the latch circuit 51A are described below. The latch circuit 51A to be detected is a synchronization-type logic circuit that operates synchronously with the signal input into the clock input terminal CK. In other words, the latch circuit 51A is a digital circuit. The latch circuit 51A to be detected is a circuit that detects a rising edge or a falling edge of the signal, which is input into the clock input terminal CK, and takes in the signal, which is input into the data input terminal D, at the detection as a trigger, for example. For example, a D-type flip flop (hereinafter referred to as FF) is a circuit that performs an edge operation in the above-described manner. The signal that is input into the clock input terminal CK of the latch circuit 51A to be detected has a single polarity, and the latch circuit 51A to be detected is driven by a single edge. As for the single polarity of the signal, for example, the clock is a negative signal but a positive signal. As for the operation in the single edge, for example, the operation in the rising edge is performed and the operation in the falling edge is not performed.

More specifically, the FF 51A is detected as the latch circuit 51A. At this time, the detection conditions do not depend whether the FF 51A includes the clock gating circuit as well as the combinational circuit 6. In other words, the FF 51A that is not included in the clock gating circuit is detected. Therefore, the FF 51A included in the clock gating circuit and the FF 51A that is not included in the clock gating circuit are detected to be a substitution target. In other words, all of the FFs 51A included in the circuit data are detected to be a substitution target. The substitution circuit 5 includes the selection circuit 52 and the latch circuit 51. As described below, the FF 51A is logically equivalent to the substitution circuit 5. Therefore, regarding the substitution circuit data for simulation, even if the FF 51A is substituted by the substitution circuit 5, the simulation is performed without any problem.

Accordingly, all the FFs 51 included in the substitution circuit data operates the reference clock as a base clock. The FF 51 detects the rising edge of the reference clock and operates. The frequency of the reference clock is equivalent to or higher than the highest frequency among the frequencies used in the substitution circuit data.

The FF 51A is detected in the circuit data when the circuit name is “FF”, for example. The circuit name in the circuit data indicates identification information that uniquely specifies a type of circuit such as FF.

The detected FF 51A is substituted by the substitution circuit 5. The substitution circuit 5 is read out from the library 14 in advance of substituting processing after the detection of the latch circuit 51A, for example.

FIGS. 6A and 6B are explanation diagrams of circuit data conversion. FIG. 6A illustrates a logic table of the clock gating circuit 3 before the substitution illustrated in FIG. 5. FIG. 6B illustrates a logic table of the clock gating circuit 4 after the substitution illustrated in FIG. 5.

In FIGS. 6A and 6B, the input into the reset terminal R of the FF 51A or the FF 51, that is, the value of the reset signal is “0” or “1”. For example, “0” of the reset signal is 0 (V), and “1” is a negative voltage of a predetermined value. If the reset signal is “0”, the FF 51A or the FF 51 is reset. If the reset signal is “1”, the FF 51A or the FF 51 is not reset.

In the logic table of the clock gating circuit 3 before the substitution illustrated in FIG. 6A, the input into the reset terminal R is indicated as a signal R, the input into the data input terminal D is indicated as a signal D, the input into the clock input terminal CK is indicated as a signal CK, and the output from the data output terminal Q is indicated as a signal Q.

In the logic table of the clock gating circuit 3 before the substitution illustrated in FIG. 6A, the FF 51A is reset if the signal R is “0”. Therefore, the signal D and the signal CK are “X” (Don't Care), and the value of the signal R is “0”. This state is a first state.

If the signal R is “1”, the signal D is “0”. If the signal CK is “rising edge R”, the input “0” is taken. Thus, the signal Q is “0”. This state is a second state. If the signal R is “1”, the signal D is “1”. If the signal CK is “rising edge R”, the input “1” is taken. Thus, the signal Q is “1”. This state is a third state. If the signal R is “1” and the signal CK is “falling edge F”, the input is not taken. Thus, the signal D is “X” (Don't Care) and the signal Q is “Q”. The output is maintained. This state is a fourth state.

In the logic table of the clock gating circuit 4 after the substitution illustrated in FIG. 6B, the input into the reset terminal R is indicated as a signal IR, the input into the input terminal A is indicated as a signal ID, the input into the control signal input terminal S is indicated as a signal R, the output from the data output terminal Z is indicated as a signal Z, the input into a data input terminal D is indicated as a signal D, the input into the clock input terminal CK is indicated as a signal CK, and the output from the data output terminal Q is indicated as a signal Q.

The signal Q is input into the input terminal B. The signal IR is a reset signal and equivalent to the signal R. The signal ID is input data and is input into the input terminal A of the selection circuit but into the data input terminal D of the FF 51A. The reference clock is used as the signal CK.

In the logic table of the clock gating circuit 4 after the substitution illustrated in FIG. 6B, the FF 51 is reset if the signal IR is “0”. Therefore, the signal ID, the signal S, the signal Z, the signal D, and the signal CK are “X” (Don't Care), and the value of the signal Q is “0”. This state corresponds to the first state.

If the signal IR is “1” and the signal S is “0”, the input into the input terminal A is selected. If the signal ID is “0”, the signal Z is the input “0” into the input terminal A. At this time, if the signal CK is “rising edge R”, the signal Z, that is, the input “0” into the input terminal A is taken. Thus, the signal Q is “0”. This state corresponds to the second state.

If the signal IR is “1”, the signal S is “0”, and the signal ID is “1”, the signal Z is the input “1” into the input terminal A. At this time, if the signal CK is “rising edge R”, the signal Z, that is, the input “1” into the input terminal A is taken, so that the signal Q is “1”. Thus, the signal Q is “1”. This state corresponds to the third embodiment.

If the signal IR is “1” and the signal S is “1”, the input into the input terminal B is selected. Therefore, the signal ID is “X” (Don't Care), and the signal Z is the input “Q” into the input terminal B. At this time, if the signal CK is “rising edge R”, the signal Z, that is, the input “Q” into the input terminal B is taken. Thus, the signal Q is “Q”, and the output is maintained. This state is a fifth state which does not correspond to any of the first, second, third, or fourth states. According to the fifth state, the cycle that holds the value Q is achieved.

If the signal IR is “1” and the signal CK is “falling edge F”, the input is not taken. The signal ID, the signal S, the signal Z, and the signal D are “X” (Don't Care), and the signal Q is “Q”. The output is maintained. This state corresponds to the fourth state.

Accordingly, the clock gating circuit 4 after the substitution is equivalent to the clock gating circuit 3 before the substitution, and the clock gating circuit 4 includes a cycle that holds the value Q.

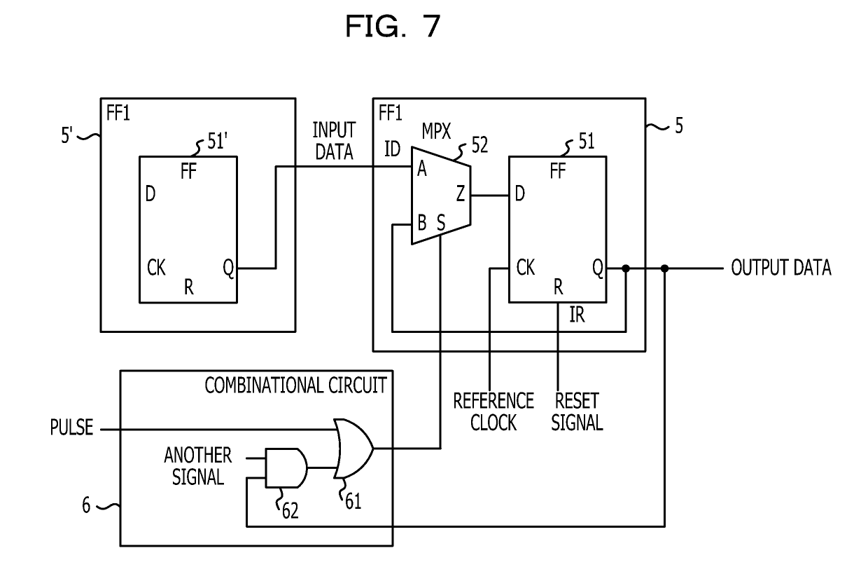

FIG. 7, which is an explanation diagram of circuit data conversion, illustrates an example of substitution circuit data that includes the clock gating circuit 4 after the substitution.

Regarding the substitution circuit data, the FF 51A included in the clock gating circuit 3 is substituted by the substitution circuit 5. The signal from an FF 51′ included in the clock gating circuit 4 in the preceding stage is input as input data into the input terminal A of the selection circuit 52. The signal from the combinational circuit 6 is input as a control signal into the control signal input terminal S of the selection circuit 52.

The combinational circuit 6 includes, for example, an OR gate 61 and an AND gate 62. If both “another signal” to be input into the AND gate 62 and the signal from the data output terminal Q are at a high level, “1” is output from the combinational circuit 6. As a result, the supply of pulse to the FF 51 is stopped, and the data is held by the FF 51. The combinational circuit 6 may employ various configurations other than the configuration illustrated in FIG. 7.

With reference to FIGS. 8 to 13, the simulation processing performed by the simulation unit 12 will be described in detail below.

FIG. 8 is an explanation diagram of simulation.

Based on the substitution circuit data that is read out from the substitution circuit data storage unit 15, the simulation unit 12 configures the verification target logic circuit 2 as a simulation model. For example, the simulation unit 12 is an emulator that achieves the logic circuit, which is expressed by the substitution circuit data, as the verification target logic circuit 2 by hardware and software.

The verification target logic circuit 2 includes a plurality of substitution circuits 5. The reference clock supplied to the simulation unit 12 from the reference clock generating unit 17 is input into all of the substitution circuits 5. A pulse A that is supplied to the simulation unit 12 from the pulse generating unit 16 is input through a clock wire into the prescribed substitution circuit 5. A pulse B that is supplied to the simulation unit 12 from the pulse generating unit 16 is input through the clock wire into another prescribed substitution circuit 5. For example, the pulse A is a frequency with 2 GHz, and the pulse B is a frequency with 1 GHz.

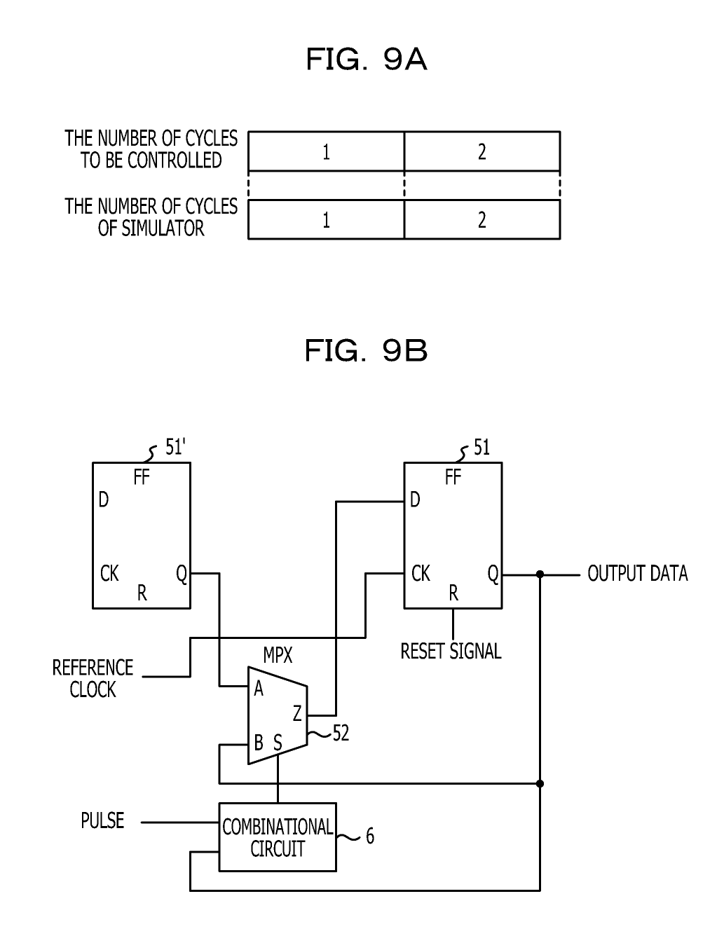

FIGS. 9A and 9B are explanation diagrams of simulation.

As illustrated in FIG. 9, the substitution circuit 5 includes the FF 51 and the selection circuit 52. The reference clock is input into the clock input terminal CK of the FF 51. The pulse is input into the combinational circuit 6. The FF 51 detects a rising edge of the reference clock and operates. If the input into the control signal input terminal S is at a low level, the selection circuit 52 selects and outputs the signal that is input into the input terminal A. If the input into the control signal input terminal S is at the high level, the selection circuit 52 selects and outputs the signal that is input into the input terminal B, that is, the output data of the FF 51.

The signal from the FF 51′ included in the clock gating circuit 4 in the preceding stage is input as input data into the input terminal A of the selection circuit 52. The output of the FF 51 is input into the input terminal B of the selection circuit 52. The output of the FF 51 is input into the combinational circuit 6 separately from into the selection circuit 52. The signal from the combinational circuit 6 is input as a control signal into the control signal input terminal S of the selection circuit 52. The output of the selection circuit 52 is input into the data input terminal D.

As described above, the feedback loop starting from the data output terminal Q to the clock input terminal CK of the FF 51 is removed. Therefore, the Cycle Based simulation is performed, and insertion of the buffer FF 153 illustrated in FIG. 2B is not typically desired.

Since the insertion of the buffer FF 153 is not typically desired, as illustrated in FIG. 2A, the first cycle in which the buffer FF 153 takes in the output of the FF 151 is not desired to be separated from the second cycle in which the output of the buffer FF 153 is input into the combinational circuit 152 and the clock input terminal CK.

Therefore, as illustrated in FIG. 9A, the 1 cycle of the clock used in the clock gating circuit is equivalent to the 1 cycle of the system clock for simulation. In other words, the ratio between the number of cycles of the simulator and the number of clock cycles is 1:1. In FIG. 9A, “the number of cycles to be controlled” indicates the number of cycles of the pulse to be input into the combinational circuit 152, and “the number of cycles of the simulator” indicates the number of cycles of the system clock of the simulation apparatus.

In this manner, compared to the number of cycles of the clock desired for the operation of the clock gating circuit, the number of cycles of the system clock desired for simulation does not increase. As a result, the calculation efficiency of the simulation apparatus is prevented from deteriorating.

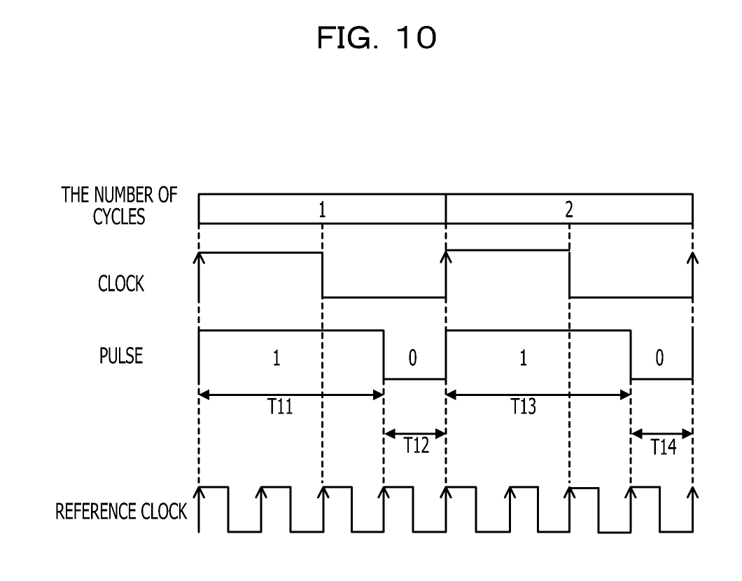

FIG. 10 is an explanation diagram of simulation.

In FIG. 10, as described above, since the ratio between “the number of cycles of the simulator” and “the number of clock cycles” is 1:1, the ratio is indicated as “the number of cycles.” The clock is a clock that is input into the clock gating circuit 3 before the substitution illustrated in FIG. 5. The pulse is input into the clock gating circuit 4 after the substitution illustrated in FIG. 5.

In FIG. 10, the cycles indicated as “the number of cycles” does not match the cycle of the reference clock. The simulation unit 12 inputs the pulse, which has a prescribed relation with the reference clock, as a clock into the combinational circuit 6 and inputs the reference clock into the FF 51.

Accordingly, the simulation with respect to the generated substitution circuit data is performed.

In FIG. 10, the pulse specifies a data take-in period and a data hold period of the input data of the FF 51 based on the reference clock. The ratio between the data take-in period and the data hold period is specified in advance.

According to the reference clock, the simulation unit 12 assigns the period with the specified pulse to the data take-in period or the data hold period of the input data. Periods T11 to T14 are timing specified by the pulse. More specifically, the periods T11 and T13 are the data hold period, and the periods T12 and T14 are the data take-in period. Regarding a waveform of the clock and the reference clock, the arrow indicated by overlapping the rising edge represents an edge that is timing at which the FF 51 is driven.

As described above, the pulse is input into the control signal input terminal S of the selection circuit 52 through the combinational circuit 6. Accordingly, the period T11 and T13 in which the pulse is “1” corresponds to a case where the signal S is “1” in the logic table illustrated in FIG. 6B. If the signal S is “1”, the input “Q” into the input terminal B is taken at timing when the reference clock as the signal CK is “rising edge R”. The output Q is held.

On the other hand, the periods T12 and T14 in which the pulse is “0” correspond to a case where the signal is “0” in the logic table illustrated in FIG. 6B. If the signal S is “0”, an input “ID” into the input terminal A is taken at timing when the reference clock as the signal CK is “rising edge R”. More specifically, the input ID “0” or “1” is taken and is then output.

As described above, the FF 51 is controlled to be state-transited by the reference clock and the pulse. In other words, the state of the FF 51 is controlled by the output Z of the selection circuit 52 and the rising edge of the reference clock. The ratio between the data hold periods T11 and T13 and the data taken-in periods T12 and T14 is specified in advanced. In other words, the pulse and other signals are supplied to achieve the periods T11 to T14.

FIG. 11 illustrates, for example, the simulation by the pulse A illustrated in FIG. 8. The pulse with frequency 2 GHz that is equal to frequency 2 GHz of the reference clock is used as the pulse A.

At the timing of the edge of the rising edge of the reference clock, the pulse A is at the low level, and the low level is input into the control signal input terminal S of the selection circuit 52. Therefore, the input data is taken by the FF 51 according to the rising edge of the first reference clock. The taken input data is output as the output data from the FF 51 according to the rising edge of the following reference clock.

In a period T21 in which the pulse A is at the high level, the high level is input into the control signal input terminal S of the selection circuit 52. Thus, the period T21 is the data hold period. In a period T22 in which the pulse A is at the low level, the low level is input into the control signal input terminal S of the selection circuit 52. Thus, the period T22 is the data take-in period. Hereinafter, in each cycle of the reference clock, the data hold period T21 and the data taken-in period T22 are repeated.

In a period T23 as previously specified timing, the output of the combinational circuit 6 is at the high level. Therefore, the supply of the pulse to the selection circuit 52 of the clock gating circuit 4 is stopped, and the data is held. Therefore, the period T23 is the data hold period in which the supply of the pulse is stopped.

In the period T23, “another signal” that is input into the AND gate illustrated in FIG. 7 and the output Q of the FF 51 are at the high level at the timing of detection of the rising edge of the sixth reference clock from the first reference clock. Since the high level is taken by the selection circuit 52, the data is held. Then, the FF 51 is state-transited.

The pulse A, which is the highest frequency 2 GHz in the verification target logic circuit 2, corresponds to the reference clock of 2 GHz and also corresponds to the system clock of the simulation apparatus 1. If the pulse A, the reference clock, and the system clock of the simulation apparatus 1 are corresponded to each other, the pulse A is at the low level at the timing of detection of the rising edge of the reference clock as described above.

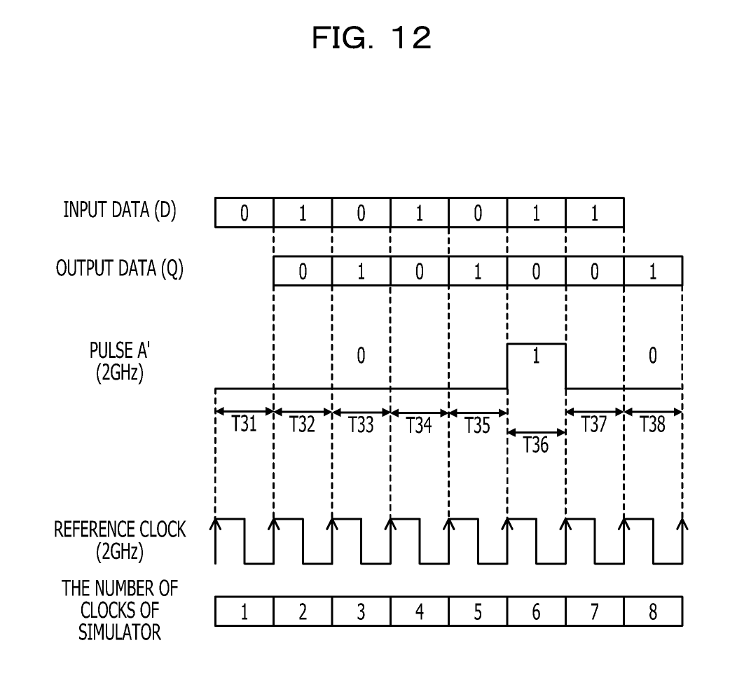

FIG. 12 illustrates another example of simulation and illustrates another simulation by the pulse A illustrated in FIG. 8. The pulse of the frequency 2 GHz, which is equal to the frequency 2 GHz of the reference clock, is used as the pulse A.

In FIG. 12 as illustrated in FIG. 11, the pulse A is the highest frequency 2 GHz in the verification target logic circuit 2. The pulse A corresponds to the reference clock of 2 GHz and also corresponds to the system clock of the simulation apparatus 1. If the reference clock of the pulse A corresponds to the system clock of the simulation apparatus 1, a pulse A′ with a waveform illustrated in FIG. 12 may be used.

At the timing of detection of the rising edge of the reference clock, the pulse A with consecutive low levels is at the low level, and the low level is input into the control signal S of the selection circuit 52. Therefore, the input data is taken by the FF 51 according to the rising edge of the first reference clock. The taken input data is output as the output data from the FF 51 according to the rising edge of the next reference clock.

In periods T31 to T35 in which the pulse A′ is at the low level, the low level is input into the control signal input terminal S of the selection circuit 52. Thus, the periods T31 to T35 are the data taken-in period. In a period T36 as timing that is previously specified, the output of the combinational circuit 6 is at the high level. Therefore, the supply of the pulse to the selection circuit 52 of the clock gating circuit 4 is stopped, and the data is held. Therefore, the period T36 is a data hold period in which the supply of the pulse is stopped.

In the period T36, “another signal” that is input into the AND gate illustrated in FIG. 7 and the output Q of the FF 51 are at the high level at the timing of detection of the rising edge of the sixth reference clock from the first reference clock. Since the high level is taken by the selection circuit 52, the data is held. Then, the FF 51 is state-transited.

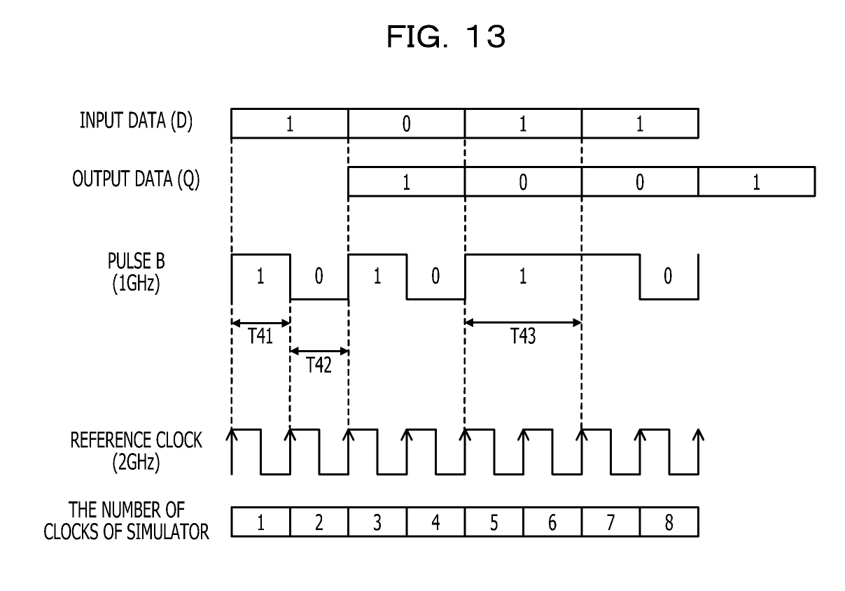

FIG. 13 illustrates, for example, the simulation by a pulse B illustrated in FIG. 8. The pulse of frequency 1 GHz, which is half the frequency 2 GHz of the reference clock, is used as the pulse B.

At the timing of the rising edge of the first reference clock, the pulse B is at the low level, and the low level is input into the control signal input terminal S of the selection circuit 52. Therefore, the input data is taken by the FF 51 according to the rising edge of the first reference clock.

In a period T41 in which the pulse B is at the high level, the high level is input into the control signal input terminal S of the selection circuit 52. Thus, the period T41 is a data hold period. In a period T42 in which the pulse B is at the low level, the low level is input into the control signal input terminal S of the selection circuit 52. Thus, the period T42 is a data taken-in period. Hereinafter, for each cycle of the pulse B, the data hold period T41 and the data taken-in period T42 are repeated.

The taken input data is output as the output data from the FF 51 according to the rising edge of the second reference clock from the first reference clock.

In the period T42 as timing that is previously specified, the output of the combinational circuit 6 is at the high level. Due to this, the supply of the pulse to the selection circuit 52 of the clock gating circuit 4 is stopped, and the data is held. Therefore, the period T43 is a data hold period in which the supply of the pulse is stopped.

In the period T43, “another signal” that is input into the AND gate illustrated in FIG. 7 and the output Q of the FF 51 are at the high level at the timing of detection of the rising edge of the fifth and sixth reference clocks from the first reference clock. Since the high level is taken by the selection circuit 52, the data is held. Then, the FF 51 is state-transited.

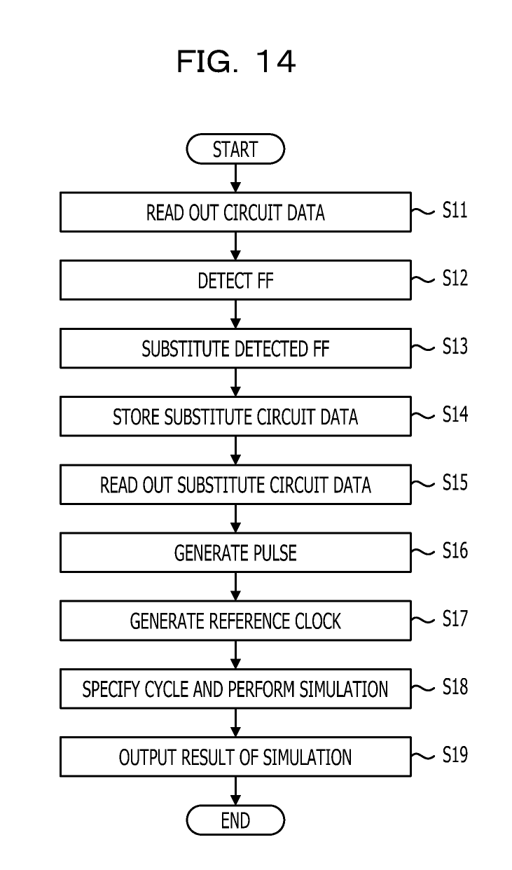

FIG. 14 is a simulation processing flowchart.

The circuit data converting unit 11 reads out the circuit data from the circuit data storage unit 13 (Operation S11). Before the start of the simulation, the circuit data is stored in the circuit data storage unit 13.

The circuit data converting unit 11 detects the FF 51 included in the read-out circuit data (Operation S12). For example, a plurality of FFs 51 is detected.

After that, the circuit data converting unit 11 reads out, from the library 14, the substitution circuit 5 of which the FF 51A is desired to be substituted. The substitution circuit 5 includes the selection circuit 52 and the FF 51. The circuit data converting unit 11 substitutes each of the detected FFs 51A respectively by the substitution circuit 5 (Operation S13). Accordingly, substitution circuit data is generated. The circuit data converting unit 11 stores the generated circuit data in the substitution circuit data storage unit 15 (Operation S14).

The simulation unit 12 reads out the substitution circuit data from the substitution circuit data storage unit 15 (Operation S15). The pulse generating unit 16 generates and supplies the pulse to the simulation unit 12 (Operation S16), and the reference clock generating unit 17 generates and supplies the reference clock to the simulation unit 12 (Operation S17).

After that, the simulation unit 12 uses the supplied pulse and reference clock to perform the Cycle Based simulation for the previously specified number of cycles (Operation S18), and outputs a result of the simulation from the input/output unit 18 (Operation S19). As a result, a user of the simulation apparatus 1 knows the result of the Cycle Based simulation.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention.

Although the embodiment of the present invention has been described in detail, it should be understood that the various changes, substitutions, and alterations could be made hereto without departing from the spirit and scope of the invention.

What is claimed is:

1. A simulation apparatus comprising:
a storage device that stores a block of circuit data including a clock gating circuit including a control circuit and a first latch circuit, wherein the control circuit outputs a control signal according to a clock, and wherein the first latch circuit holds or outputs a block of input data according to the control signal; and
a processor that executes a program having a procedure, the procedure including:
generating a block of substitution circuit data by substituting the first latch circuit by a selection circuit and a second latch circuit, wherein the selection circuit selectively outputs one of the input data and a block of output data according to the control signal, wherein an output of the selection circuit is input into a data input terminal and a reference clock is input into a clock input terminal in the second latch circuit, and wherein the second latch circuit outputs the output of the selection circuit as the output data according to the reference clock from a data output terminal; and
performing a simulation with respect to the substitution circuit data using a pulse related to the reference clock and the reference clock.

2. The simulation apparatus according to claim 1, wherein a prescribed period of the pulse is assigned to one of a take-in period and a hold period of the input data according to the reference clock in performance of the simulation.

3. The simulation apparatus according to claim 1, the procedure further including:
generating the pulse; and
generating one of a frequency that is equal to the pulse and the reference clock of the frequency of an integral multiple.

4. The simulation apparatus according to claim 1, wherein the simulation is Cycle Based simulation, and
wherein the simulation of a prescribed number of cycles is performed in the performance of the simulation.

5. The simulation apparatus according to claim 4, wherein the second latch circuit is a flip flop that operates synchronously with a signal to be input into the clock input terminal, detects one of a rising edge and a falling edge of the signal to be input into the clock input terminal, and takes in the signal to be input into the data input terminal.

6. A simulation method comprising:
reading out the circuit data including the clock gating circuit including the control circuit and the first latch circuit, wherein the control circuit outputs the control signal according to the clock and wherein the first latch holds or outputs the input data according to the control signal;
generating the substitution circuit data by substituting the first latch circuit by the selection circuit and the second latch circuit, wherein the selection circuit selectively outputs one of the input data and the output data of the latch circuit according to the control signal, wherein the output of the selection circuit is input into the data input terminal, the reference clock is input into the clock input terminal in the second latch circuit, and wherein the second latch circuit outputs the output of the selection circuit as the output data from the data output terminal according to the reference clock; and
performing a simulation with respect to the substitution circuit data using a pulse related to the reference clock and the reference clock.

7. The simulation method according to claim 6, wherein the prescribed period of the pulse is assigned to one of the take-in period and the hold period of the input data according to the reference clock in the performance of the simulation.

8. The simulation apparatus according to claim 6, further comprising:
generating the pulse; and
generating the reference clock of one of the frequency that is equal to the pulse and the frequency of an integral multiple.

9. The simulation method according to claim 6, wherein the simulation is Cycle Based simulation, and
wherein the simulation of the prescribed number of cycles is performed in the performance of the simulation.

10. The simulation method to claim 9, wherein the second latch circuit is a flip flop that operates synchronously with a signal to be input into the clock input terminal, detects one of the rising edge and the falling edge of the signal to be input into the clock input terminal, and takes in the signal to be input into the data input terminal.

11. A computer-readable recording medium which stores a simulation program for directing a simulation apparatus to perform a process, the process comprising:
reading out a block of circuit data including a clock gating circuit including a control circuit and a first latch circuit, wherein the control circuit outputs a control signal according to a clock, and wherein the first latch circuit holds or outputs a block of input data according to the control signal;
generating a block of substitution circuit data by substituting the first latch circuit by a selection circuit and a second latch circuit, wherein the selection circuit outputs one of the input data and the output data of the latch circuit according to the control signal, wherein the output of the selection circuit is input into the data input terminal, the reference clock is input into the clock input terminal, and the output of the selection circuit is output as the output data from the data output terminal according to the reference clock; and
performing a simulation with respect to the substitution circuit data using a pulse related to the reference clock and the reference clock.

12. The non-transitory computer-readable recording medium according to claim 11, wherein the prescribed period of the pulse is assigned to one of the take-in period and the hold period of the input data according to the reference clock in the performance of the simulation.

13. The non-transitory computer-readable recording medium according to claim 11, the process further comprising:
generating the pulse; and
generating the reference signal of one of the frequency that is equal to the pulse and the frequency of the integral multiple.

14. The non-transitory computer-readable recording medium according to claim 11, wherein the simulation is Cycle Based simulation, and
wherein the simulation of the prescribed number of cycles is performed in the performance of the simulation.

15. The non-transitory computer-readable recording medium according to claim 14, wherein the second latch circuit is a flip flop that operates synchronously with the signal to be input into the clock input terminal, detects one of the rising edge and the falling edge of the signal to be input into the clock input terminal, and takes in the signal to be input into the data input terminal.
